(19) United States
(12) Patent Application Publication
(10) Pub. No.: US 2012/0103919 A1
(43) Pub. Date: May 3, 2012

(54) Methods for Treating Oilfield Water

(76) Inventors: Johanna A. Haggstrom, Duncan, OK (US); Jason E. Bryant, Duncan, OK (US); Jeremy Holtsclaw, Lawton, OK (US); Jim D. Weaver, Duncan, OK (US)

(21) Appl. No.: 12/913,816

(22) Filed: Oct. 28, 2010

(51) Int. Cl. C02F 1/72; C02F 1/68

(52) U.S. Cl. 210/758

(57) ABSTRACT

The present invention describes the treatment of contaminated oilfield water, and more particularly, to methods of treating bacteria contaminated and organic chemical contaminated oilfield water to reduce or eliminate such contamination using high-oxidation state iron ions. The described methods involve providing oilfield water wherein the oilfield water has a first biological load; providing high-oxidation state iron ions, combining the oilfield water and the high-oxidation state iron ions; and, allowing the high-oxidation state iron ions to reduce the biological load to a lower biological load to create treated oilfield water.

### BACKGROUND

The present invention relates to the treatment of contaminated oilfield water, and more particularly, to methods of treating bacteria-contaminated and/or organic chemical contaminated oilfield water to reduce or eliminate contamination using high-oxidation state iron ions.

Oilfield water generally includes three sources: flow-back water, produced water, and surface water. As used herein, the term “flow-back water” refers to water that flows back to the surface after being placed into a subterranean formation as part of a treatment operation. As used herein, the term “produced water” refers to water that is naturally occurring within a subterranean formation that is produced to the surface either as part of a treatment operation or during production. As used herein, the term “surface water” refers to water such as pond and river water that is being prepared for use in a subterranean formation.

Bacteria in oilfield water can be aerobic or anaerobic. One known type of anaerobic bacteria are desulfovibrio bacteria or SRB (sulfate reducing bacteria), which are present in nearly all waters handled in oilfield operations. SRBs convert sulfate ions into hydrogen sulfide—leading to reservoir souring. Hydrogen sulfide is acidic and can in turn cause sulfide scales, most importantly, iron sulfides. In addition, hydrogen sulfide is corrosive to iron pipes, tools, and other equipment. The etching away of the metal often leads to the development of the scale deposits. Solid deposits of bacterial colonies are called “biofilms” or “biofouling.” The presence of iron sulfide or an increase in the water soluble sulfide concentration in a flow line is a strong indicator of microbially induced corrosion (MIC); therefore it is very important to prevent the formation of biofilms on the surfaces of flow lines and other production equipment. It is similarly important to have viable treatment strategies for both planktonic and sessile bacterial numbers. The potential for SRB activity is greater when produced water or flow-back water is reinjected into a subterranean formation. Water that is reinjected can be a mixture of produced water and seawater. Flow-back water often includes a mixture of SRB nutrients including sulfate ions, organic carbon, and nitrogen. There are SRBs that can survive extremes of temperature, pressure, salinity, and pH, but their growth is particularly favored in the temperature range of about 40° F. to about 175° F.

The presence of bacteria in an oil and/or gas producing formation, and particularly SRBs, cause a variety of problems. If the bacteria produce sludge or slime, they can cause a reduction in the porosity of the formation which in turn reduces the production of oil and/or gas therefrom. Sulfate reducing bacteria produce hydrogen sulfide, and the problems associated with hydrogen sulfide production, even in small quantities, are well known. The presence of hydrogen sulfide in produced oil and gas can cause excessive corrosion in metal tubular goods and surface equipment, a lower oil selling price, and the necessity to remove hydrogen sulfide from gas prior to sale.

Bacteria-contaminated formations that are subjected to stimulation treatments such as fracturing have heretofore been particularly difficult or impossible to treat. That is, prior attempts to introduce one or more bactericides into such formations to contact and kill the bacteria therein have been largely unsuccessful due to the bacteria being located in or near fractures at long distances from the well bores. When treating fluids containing bactericides have been pumped into such previously fractured contaminated formations, the treating fluids have either failed to reach the locations of the bacteria, and/or the proppant materials in the previously formed fractures have been disturbed thereby reducing the productivities of the formations.

A biocide is a chemical substance capable of killing living organisms, usually in a selective way. Biocides are commonly used in medicine, agriculture, forestry, and in industry where they prevent the fouling of water and oil pipelines. Microorganisms may be present in well bore treatment fluids as a result of contaminations that are present initially in the base treatment fluid that is used in the treatment fluid or as a result of the recycling/reuse of a well bore treatment fluid to be used as a base treatment fluid for a treatment fluid or as a treatment fluid itself. In either event, the water can be contaminated with a plethora of microorganisms.

Biocides, also called bactericides or antimicrobials, are commonly used to counteract biological contamination. The term “biological contamination,” as used herein, may refer to any living microorganism and/or by-product of a living microorganism found in treatment fluids used in well treatments. Their aim is to kill microorganisms, especially bacteria, or interfere with their activity. Microorganisms in oilfields or in injection water are generally classified by their effect. Sulfate-reducing bacteria (SRBs), denitrifying bacteria (hNRB), slime-forming bacteria (NR-SOB), yeast and molds, and protozoa can be encountered in nearly any body of water present in and around an oil field. Bacteria may be found in solution (planktonic), as dispersed colonies or immobile deposits (sessile bacteria). Bacteria can use a wide variety of nitrogen, phosphorus, and carbon compounds (such as organic acids) to sustain growth. Nitrogen and phosphorus are usually sufficiently present in the formation water to sustain bacterial growth, but injection of organic nitrogen- and phosphorus-containing chemicals in fluid inserted into the formation can further increase growth potential.

Because biocides are intended to kill living organisms, many biocidal products pose significant risks to human health and welfare. In some cases, this is due to the high reactivity of the biocides. As a result, their use is often heavily regulated and great care is necessary when handling such biocides. Storage of such biocides also may be an important consideration.

As an alternative to traditional biocides, high intensity UV light has been used to kill bacteria in aqueous liquids. There are three UV-light classifications: UV-A, UV-B, and UV-C. The UV-C class is considered the germicidal wavelength, with the germicidal activity being at its peak at a wavelength of 254 nm. The rate at which UV light kills microorganisms in a treatment fluid is a function of various factors including, but not limited to, the time of exposure and flux (i.e., intensity) to which the microorganisms are subjected. For example, in a flow through cell type embodiment, a problem that may be associated with conventional UV light treatment systems is that inadequate penetration of the UV light into an opaque treatment fluid may result in an inadequate kill. Additionally, in such situations, to achieve optimal results, it is desirable to maintain the exposure to UV light at a sufficient flux for as long a period of time as possible to maximize the degree of penetration so that the biocidal effect produced by the UV light treatment may be increased. Another challenge is the turbidity of the treatment fluid. “Turbidity,” as that term is used herein, is the cloudiness or haziness of a treatment fluid caused by individual particles (e.g., suspended solids) and other contributing factors that may be generally invisible to the naked eye. The measurement of turbidity is a key test of water quality. The partial killing of the bacteria can result in the re-occurrence of the contamination, which is highly undesirable in the subterranean formation.

In addition to bacterial contamination, oilfield water can also be contaminated with organic chemicals such as organics naturally occurring in the formation, treatment chemicals (such as viscosifiers, emulsion stabilizers, etc.) and production chemicals (such as scale reducers, friction reducers, etc.). This is particularly true of flow-back water and produced waters. These organic chemicals may lead to increased bacterial contamination (in the cases where the polymeric material serves as food for the bacteria). Moreover, the presence of organic chemicals can interfere with later re-use of the water. For example, if the organic chemical contamination includes charged polymers, they may interfere with surfactants chosen for later use, organic chemical contamination could also negatively effect hydration of viscosifiers, the formation of emulsions, or the formation of crosslinks and could consume breakers added to the water.

### SUMMARY

The present invention relates to the treatment of contaminated oilfield water, and more particularly, to methods of treating bacteria-contaminated and/or organic chemical contaminated oilfield water to reduce or eliminate contamination using high-oxidation state iron ions.

Some embodiments of the present invention provide methods of treating oilfield water comprising: providing oilfield water wherein the oilfield water has a first biological load; providing high-oxidation state iron ions; combining the oilfield water and the high-oxidation state iron ions; and, allowing the high-oxidation state iron ions to lower the amount of biological load to a second biological load to create treated oilfield water.

Other embodiments of the present invention provide methods of treating oilfield water comprising: providing oilfield water wherein the oilfield water comprises organic contamination having a first organic load and biological contamination having a first biological load; providing high-oxidation state iron ions; combining the oilfield water and the high-oxidation state iron ions such that the high-oxidation state iron ions lower the amount of biological load to a second biological load and such that the high-oxidation state iron ions oxidize a portion of the organic contamination so as to reduce the organic contamination load to a second organic contamination load.

The features and advantages of the present invention will be readily apparent to those skilled in the art upon a reading of the description of the preferred embodiments that follows.

### BRIEF DESCRIPTION OF THE DRAWINGS

FIG. 1 shows the effect of a high-oxidation state iron ion treatment on friction reduction performance.

### DESCRIPTION OF THE PREFERRED EMBODIMENTS

The present invention relates to the treatment of contaminated oilfield water, and more particularly, to methods of treating bacteria-contaminated and/or organic chemical contaminated oilfield water to reduce or eliminate contamination using high-oxidation state iron ions.

The ferrate ion, FeO₄²⁻ is a tetrahedral ion that is believed to be isostructural with chromate (CrO₄²⁻) and permanganate (MnO⁴⁻), but ferrate exhibits a higher rate of reactivity in its oxidations and generally reacts to produce a cleaner reaction product. Ferrate is a strong oxidant that can react with a variety of inorganic or organic reducing agents and substrates. It can, therefore, act as a selective oxidant for organic species and is capable of oxidizing and thereby removing a variety of organic and inorganic compounds from waters. As is known to those of skill in the art, iron can accommodate the following oxidation states: −2, −1, 0, +1, +2, +3, +4, +5, and +6. Iron in the 0 oxidation state is elemental iron. Most compounds and salts of iron found in nature have an oxidation state of either +2 (Fe(II)) or +3 (Fe(III)). As used herein iron's oxidation state may be expressed either as “Fe+6” or “Fe(VI).” In the context of the present invention, “high-oxidation state iron ion” refers to an ion comprising iron in its +4, +5, or +6 oxidation states. That is, “high-oxidation state iron ion” as used herein refers to a substance having a single oxidation of +4 or above or a mixture of oxidation states wherein at least one state present is +4 or above. The ferrate ion contains oxygen atoms and may also comprise atoms of other elements. Thus, for example, ferrate refers to a FeO₄²⁻, where the iron is Fe(VI) and the other atoms in the ion are oxygen atoms. In some embodiments, ferrate in the +6 state is preferred.

In subterranean formations, bacteria contamination can be naturally occurring or can be introduced with treatment fluids such as drilling, injection, or fracturing fluids. In cases where contamination is introduced or spread by a treatment fluid, the bacteria might be carried from the near well bore to long distances into the formation by traveling with the treatment fluid itself. As noted above, organic biocides may be used to reduce hydrogen sulfide production, sulfide scaling, biofouling, and corrosion thereby increasing well productivity. Biocides may be particularly useful in operations that involve the injection of seawater into a subterranean operation for increased reservoir pressure or enhanced oil recovery. As noted, bacteria are nearly universally present in seawater, particularly SRBs. SRBs present in the seawater and the hydrogen sulfide formed by them can cause signification damage, known as microbially induced corrosion, to production equipment; causing pitting and potentially hole formation in equipment. For example, in the natural gas industry, it has been estimated that up to 30% of the pipeline failures due to corrosion involve microbially induced corrosion.

The methods of the present invention use high-oxidation state iron ions as a biocide to treat oilfield waters. The high-oxidation state iron ions can be used in any available form, including a solid, an ion-source produced at the site of treatment, and in solution as a salt. High-oxidation state iron ions are unique, at least in part, because they combine the action of a powerful oxidizer with relatively mild environmental impact. High-oxidation state iron ions exhibit strong oxidizing power over a broad pH range, but are most stable at pH of about 10. At pH levels below about 10 the high-oxidation state iron ions are effective, but its half-life decreases as pH decreases. In addition, high-oxidation state iron ions do not generate toxic byproducts when used as a biocide, unlike chlorine, bromine, ozone, and many other known biocides. High-oxidation state iron ions are able to oxidize nearly any unsaturated organic compound and are thus suitable to remove both biological and organic chemical contamination.

Moreover, high-oxidation state iron ions are a useful oxidizer at temperatures from just above freezing to about 50° C. In some preferred embodiments, the high-oxidation state iron ion may be used to treat water that is at or below 35° C. In other preferred embodiments, the high-oxidation state iron ion may be used to treat water that is at or below 30° C. In other preferred embodiments, the high-oxidation state iron ion may be used to treat water that is at or below 25° C. In fact, high-oxidation state iron ion may be useful as a low temperature breaker to reduce the viscosity of residual polymers in a low-temperature fluid. Such residual polymers may be naturally occurring or may have been added, particularly in the case of flow-back water, as a viscosity increaser, drag reducer, etc.

It is understood by those skilled in the art that an ion generally requires a counterion of equal, though opposite, charge, including the high-oxidation state iron ions of the present invention. The counterion may be any ion that renders neutral the overall charge of the mixture comprising the high-oxidation state iron ion. The most commonly available form of ferrate is K₂FeO₄, where the iron is in its +6 oxidation state, the ferrate is a cation and the counterion is potassium. Any other counterion, such as, and without limitation, sodium, calcium, magnesium, silver, etc., may also be used.

In the absence of a more suitable reductant, a high-oxidation state iron ion such as ferrate will react with water itself to form ferric ion and molecular oxygen according to the following equation:

4FeO₄²⁻+10H₂O→4Fe³⁺+20OH⁻+3O₂

This reaction provides a suitable mechanism for self-removal of ferrate from solution due to the fact that the final iron product is non-toxic ferric ion which then forms low toxicity hydroxide oligomers, oxides, or salts. Over time, these species flocculate and can then settle out or be filtered out of the treated water as particulate matter. Ferric oxide, typically known as rust, is the iron product of oxidation by ferrate; thus making the ferrate ion a relatively environmentally safe oxidant.

Any method of producing a high-oxidation state iron ion known in the art may be used to generate ions suitable for use in the present invention. Some known approaches to create ferrate in particular include: (1) electrolysis, (2) oxidation of Fe₂O₃ in an alkaline melt, or (3) oxidation of Fe(III) in a concentrated alkaline solution with a strong oxidant. The method of oxidizing Fe(III) is known to produce a solid form that is stable indefinitely when kept dry. One common laboratory means of producing ferrate involves the hypochlorite oxidation of Fe(III) in strongly alkaline (such as NaOH) solution followed by the precipitation of the ferrate by the addition of saturated KOH:

2Fe³⁺+3OCl⁻+10OH⁻→2FeO₄²⁻+3Cl⁻+5H₂O

The resulting purple solid is stable indefinitely when kept dry. Commercial production of ferrate typically uses a synthetic scheme similar to the laboratory preparation, also involving a hypochlorite reaction. Most commonly, using alkaline oxidation of Fe(III), potassium ferrate (K₂FeO₄) is prepared via gaseous chlorine oxidation in caustic soda of ferric hydroxide, involving a hypochlorite intermediate. Another method for ferrate production was described by Johnson in U.S. Pat. No. 5,746,994, the entire disclosure of which is hereby incorporated by reference.

Other processes for preparation of high-oxidation state iron ion are known and used, many of them also involving the reactions with hypochlorite. For example, U.S. Pat. No. 5,202,108, the entire disclosure of which is hereby incorporated by reference, discloses a process for making stable, high-purity ferrate (VI) using beta-ferric oxide (beta-Fe₂O₃) and preferably monohydrated beta-ferric oxide (beta-Fe₂O₃.H₂O), where the unused product stream can be recycled to the ferrate reactor for production of additional ferrate.

U.S. Pat. Nos. 4,385,045 and 4,551,326, the entire disclosures of which are hereby incorporated by reference, disclose a method for direct preparation of an alkali metal or alkaline earth metal ferrate from inexpensive, readily available starting materials, where the iron in the product has a valence of +4 or +6. The method involves reacting iron oxide with an alkali metal oxide or peroxide in an oxygen free atmosphere or by reacting elemental iron with an alkali metal peroxide in an oxygen free atmosphere.

U.S. Pat. No. 4,405,573, the entire disclosure of which is hereby incorporated by reference, discloses a process for making potassium ferrate in large-scale quantities (designed to be a commercial process) by reacting potassium hydroxide, chlorine, and a ferric salt in the presence of a ferrate stabilizing compound.

U.S. Pat. No. 4,500,499, the entire disclosure of which is hereby incorporated by reference, discloses a method for obtaining highly purified alkali metal or alkaline earth metal ferrate salts from a crude ferrate reaction mixture, using both batch and continuous modes of operation.

U.S. Pat. No. 4,304,760, the entire disclosure of which is hereby incorporated by reference, discloses a method for selectively removing potassium hydroxide from crystallized potassium ferrate by washing it with an aqueous solution of a potassium salt (preferably a phosphate salt to promote the stability of the ferrate in the solid phase as well as in aqueous solution) and an inorganic acid at an alkaline pH.

U.S. Pat. No. 2,758,090, the entire disclosure of which is hereby incorporated by reference, discloses a method of making ferrate, involving a reaction with hypochlorite, as well as a method of stabilizing the ferrate product so that it can be used as an oxidizing agent.

U.S. Pat. No. 2,835,553, the entire disclosure of which is hereby incorporated by reference, discloses a method, using a heating step, where novel alkali metal ferrates with a valence of +4 are prepared by reacting the ferrate (III) of an alkali metal with the oxide (or peroxide) of the same, or a different, alkali metal to yield the corresponding ferrate (IV).

U.S. Pat. No. 5,284,642, the entire disclosure of which is hereby incorporated by reference, discloses the preparation of alkali or alkaline earth metal ferrates that are stable and industrially usable as oxidizers for water treatment by oxidation. Sulfate stabilization is also disclosed.

U.S. Pat. No. 7,476,324 and U.S. Application Publication No. 2009/0120802, the entire disclosures of which are hereby incorporated by reference, disclose the preparation of ferrate for use at the site of preparation by mixing an iron salt and an oxidizing agent in a mixing chamber and then transferring the mixture to a reaction chamber. The processes described may be performed in solution phase (with or without the presence of a solvent), solid state, or electrochemical. The methods described in U.S. Pat. No. 7,476,324, and U.S. Application Publication No. 2009/0120802, the entire disclosures of which are hereby incorporated by reference, are particularly well-suited to methods wherein it is desirable to produce the ferrate on site for substantially immediate use.

In some embodiments of the present invention, the high-oxidation state iron ion may be combined with one or more traditional biocides, either oxidizing or nonoxidizing organic biocides, to achieve a synergistic biocidal effect. Traditionally, oxidizing biocides are used as the primary treatment with nonoxidizing organic biocides acting as secondary bacterial control. Traditional oxidizing biocides include chlorine; hypochlorite; hypochlorite salts (such as sodium-, lithium-, or calcium-hypochlorite); bromine; hypobromite salts (such as sodium-, lithium-, or calcium-hypobromite), bromine chloride; hydroxyl radicals; chlorine dioxide; hydrogen peroxide; sodium hydroxide; and hydrogen peroxide. Traditional organic nonoxidizing biocides include chloramines; tetrahydro-3,5-dimethyl-2H-1,3,5-thiadiazine-2-thione; 5-chloro-2-methyl-4-isothiazolin-3-one; 2-methyl-4-isothiazolin-3-one; 1,2-benzisothiazolin-3-one; tetrakis(hydroxymethyl)phosphonium sulfate; zinc pyrithione; 2-(thiocyanomethylthio)benzothiazole; 2,2-dibromo-3-nitropropionamide; benzalkonium chloride; benzyl C10-16 alkyldimethyl ammonium chloride; didecyl-dimethyl-ammonium chloride; formaldehyde; glutaraldehyde; N-cocoalkyl-1,3,-propylenediamine acetate; hexahydro-1,3,5-triethyl-s-triazine; alkyl-aryl triethylammonium chloride solution; methylene bis(thiocyanate); 2,2-dibromo-nitrilopropionamide; 2-bromo-2-nitropropane-1,3-diol; 2-methyl-5-nitroimidazole-1-ethanol; quaternary ammonium glutaraldehyde; biguanidine; alkyl dimethyl benzyl ammonium chloride (ADBAC); dialky; dimethyl ammonium chloride (DDAC); tetrakishydroxymethyl phosphonium sulfate (THPS); and tri-n-butyl tetradecyl phosphonium chloride (TTPC).

Some embodiments of the present invention provide methods of reducing the biological load in oilfield water comprising providing oilfield water and high-oxidation state iron ion, mixing the oilfield water and the high-oxidation state iron ion to allow the high-oxidation state iron ion to kill microorganisms in the oilfield water.

In some embodiments it may be desirable to filter the oilfield water after the treatment with high-oxidation state iron ions is complete. As noted above, following the oxidation reaction, the iron in the high-oxidation state iron ion becomes bound into hydroxide oligomers, oxides, or salts, or other solid or insoluble forms. Over time, these species flocculate and can then settle out of the treated oilfield water. Particularly in instances where the treated oilfield water is being prepared for use in a subsequent subterranean operation, it may be desirable to filter the treated water to remove the solid and insoluble bodies out of the water. One skilled in the art will be able to select an appropriate filter size to remove any undesirable solids or flocculants from the water. In some preferred embodiments, 10-micron filter paper may be preferred.

The methods of the present invention may be particularly well-suited for the treatment of produced or flow-back water. These waters tend to have significantly more biological and other organic contamination, including, for example, polymer contamination. The methods of the present invention can be used to treat produced or flow-back water before it is released back into the environment at the end of an operation or may be used to treat produced or flow-back water that is being prepared for use in a subterranean operation. Generally, waters that have a high load of residual organic contamination (such as polymers) are unsuitable for use in subterranean operations. This is at least in part due to the fact that the presence of polymer species and percentages are generally strictly controlled in forming subterranean treatment fluids in order to control the fluid rheology. In addition, waters having undesirable biological species generally need to be treated to avoid contaminating the subterranean environment with SRBs and other harmful species. In accordance with the methods of the present invention, high-oxidation state iron ions can be used to treat oilfield water (including production water, flow-back water, and surface water) in order to reduce both the biological load (for example, from a first biological load to a second biological load) and to aid in the breakdown of residual organic contamination in the water.

To facilitate a better understanding of the present invention, the following examples of preferred embodiments are given. In no way should the following examples be read to limit or define the scope of the invention.

### EXAMPLES

As previously described, the inclusion of friction reducing polymers in water should reduce the energy lost due to turbulence in the water. For example, the addition of the friction reducing polymer may reduce the pressure drop experienced by the water when traveling through a tubular structure (such as a pipe). As will be appreciated, the pressure drop for water traveling through a pipe with a circular cross section may be calculated with the following equation:

$$Δ {P}_{water} = \frac{ρ {V}^{2} Lf}{2 {g}_{c} d} \qquad ( 1 )$$

wherein ΔP_{water} is the calculated pressure drop for the water, ρ is density, V is the velocity of the water, L is pipe length, g_{c} is the gravitational constant and d is the pipe diameter. The variable f may be calculated in accordance with the formula below for turbulent flow.

$$f = {\{ - 2 log [ \frac{ɛ / d}{3.7} - \frac{5.02}{{N}_{Re}} log ( \frac{ɛ / d}{3.7} + \frac{14.5}{{N}_{Re }} ) ] \}}^{- 2} \qquad ( 2 )$$

wherein ε is pipe roughness, d is the pipe diameter and N_{Re} is the Reynold's Number. Accordingly, a measured pressure drop of the water traveling at a velocity V through a pipe of length L and diameter d after the addition of the friction reducing polymer may be compared to the calculated pressure drop for the water without the friction reducing polymer to determine a % Friction Reduction (“% FR”) using the following equation:

$$\% FR = 1 - \frac{Δ {P}_{measured}}{Δ {P}_{water}} \qquad ( 3 )$$

As used herein, unless otherwise noted, the % FR is the friction reduction measured in a pipe length L of 8 ft, a pipe diameter d of 0.554 inches, and a pump rate of about 10 gpm.

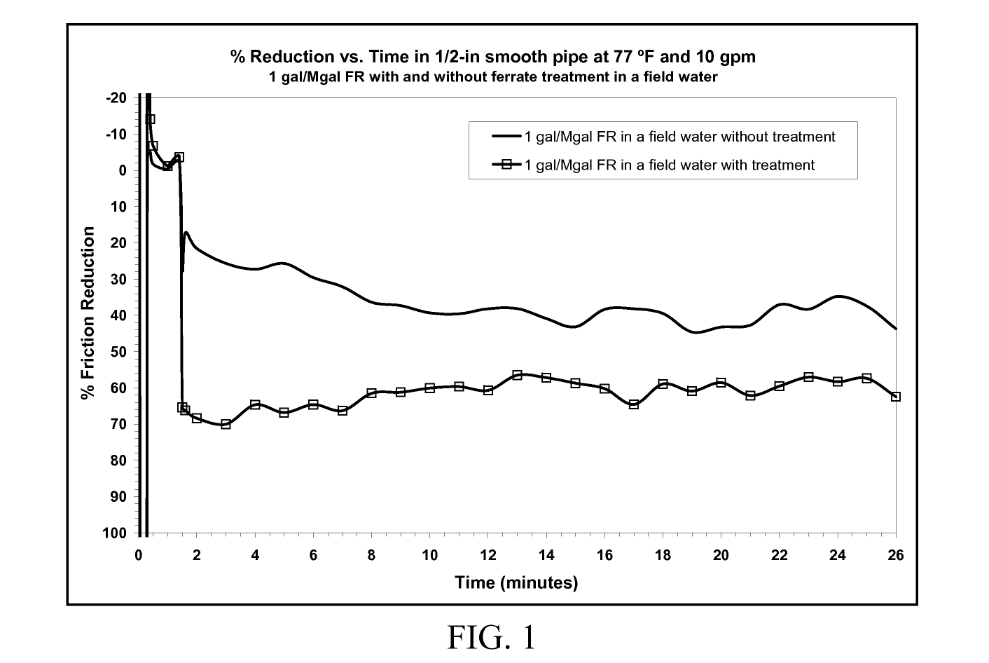

In this example, the effects of the friction reducer performance of FDP-S944-09 (a friction reducer commercially available from Halliburton Energy Services of Duncan, Okla.) was studied in a Marcellus Shale flowback water with and without the high-oxidation state iron ion treatment. For the first test, 1 gal/Mgal of FDP-S944-09 was injected into the untreated flowback water. For the second test, the flowback water was treated with 5 gal/Mgal of a concentrated potassium ferrate solution. Once the potassium ferrate solution was added, precipitates quickly formed. These precipitates were filtered from the water, and the filtered water was used to evaluate the performance of 1 gal/Mgal of FDP-S944-09. From standard water analysis measurements, the produced water was measured to contain about 11,000 milligrams per liter (mpl) of total dissolved solids (TDS), and the high-oxidation state iron ion treatment did not significantly affect the TDS of the flowback water as the treated water also contained about 11,000 mpl of TDS. The amount of total dissolved solids was relatively low, and was not expected to decrease the performance of the friction reducer significantly. It was suspected that impurities in the water such as organic contaminants may be the cause for the significant decrease in performance. The high-oxidation state iron ion treatment effectively removed these impurities, and the friction reduction performance was restored to expected values. The results are shown in FIG. 1 wherein “FR” refers to “friction reducer.”

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is hereby specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method of treating oilfield water comprising:
providing oilfield water wherein the oilfield water has a first biological load;
providing high-oxidation state iron ions;
combining the oilfield water and the high-oxidation state iron ions; and,
allowing the high-oxidation state iron ions to lower the amount of biological load to a second biological load to create treated oilfield water.

2. The method of claim 1 wherein the high-oxidation state iron ions comprise ions having an oxidation state of 6+.

3. The method of claim 1 wherein the oilfield water comprises organic contamination having a first organic contamination load and further comprising the step of
allowing the high-oxidation state iron ions to oxidize a portion of the organic contamination so as to reduce the organic contamination load to a second organic contamination load.

4. The method of claim 1 wherein the oilfield water is selected from the group consisting of produced water, flow-back water, surface water, or a combination thereof.

5. The method of claim 1 wherein the high-oxidation state iron ions are combined with an additional biocide selected from the group consisting of a traditional oxidizing biocide, a traditional organic nonoxidizing biocide, and a combination thereof.

6. The method of claim 1 wherein the pH of the oilfield water is above about 10 after combining the oilfield water and the ferrate.

7. The method of claim 1 wherein the temperature of the oilfield water is about 30° C. or below.

8. The method of claim 1 further comprising the step of:
filtering the treated oilfield water to remove solids and flocculants after the step of:
allowing the high-oxidation state iron ions to lower the amount of biological load to a second biological load.

9. A method of treating oilfield water comprising:
providing oilfield water wherein the oilfield water comprises organic contamination having a first organic load and biological contamination having a first biological load;
providing high-oxidation state iron ions;
combining the oilfield water and the high-oxidation state iron ions such that the high-oxidation state iron ions lower the amount of biological load to a second biological load and such that the high-oxidation state iron ions oxidize a portion of the organic contamination so as to reduce the organic contamination load to a second organic contamination load.

10. The method of claim 9 wherein the high-oxidation state iron ions comprise ions having an oxidation state of 6+.

11. The method of claim 9 wherein the oilfield water is selected from the group consisting of produced water, flow-back water, surface water, or a combination thereof.

12. The method of claim 9 wherein the high-oxidation state iron ions are combined with an additional biocide selected from the group consisting of a traditional oxidizing biocide, a traditional organic nonoxidizing biocide, and a combination thereof.

13. The method of claim 9 wherein the pH of the oilfield water is above about 10 after combining the oilfield water and the ferrate.

14. The method of claim 9 wherein the temperature of the oilfield water is about 30° C. or below.

15. The method of claim 9 wherein, after the step of combining the oilfield water and the high-oxidation state iron ions such that the high-oxidation state iron ions lower the amount of biological load to a second biological load and such that the high-oxidation state iron ions oxidize a portion of the organic contamination so as to reduce the organic contamination load to a second organic contamination load, further comprises the step of:
filtering the treated oilfield water to remove solids and flocculants.
